(19) United States
(12) Patent Application Publication
(10) Pub. No.: US 2005/0080197 A1
(43) Pub. Date: Apr. 14, 2005

(54) Methods for producing micro and nano-scale dispersed-phase morphologies in polymeric systems comprising at least two

(76) Inventors: Sadhan Jana, Fairlawn, OH (US); Norberto Silvi, Clifton Park, NY (US)

Correspondence Address: George W Moxon II;Roetzel & Andress, 222 South Main Street, Akron, OH, 44308, US

(21) Appl. No.: 10/487,662

(22) PCT Filed: Jul. 3, 2002
(86) PCT No.: PCT/US02/21060

Related U.S. Application Data
(60) Provisional application No. 60/302,770, filed on Jul. 3, 2001.

(51) Int. Cl. C08L 23/00

(52) U.S. Cl. 525/240

(57) ABSTRACT

A polymeric system is disclosed wherein at least one minor polymeric component is dispersed into a major polymeric component such that the minor polymeric component is dispersed with less than micro-scale dispersed-phase morphologies.

### FIELD OF INVENTION

This invention relates to a method that produces micro- and nano-scale dispersed-phase morphologies in polymeric systems comprising at least two components.

### BACKGROUND OF THE INVENTION

Polymeric systems comprise at least two components—a major and a minor component. Producing polymeric systems comprising at least two components mandates dispersing the minor component into the major component. Conventional manufacturing processes typically utilize single or twin screw extruders to this end. When the minor component is thoroughly mixed into the major component, it is otherwise known as the dispersed minor phase. The morphology—general size and shape—of the dispersed minor phase affects the overall mechanical and chemical properties of the polymeric system. The smaller the dispersed-phase morphologies tend to be, the better the resulting mechanical and chemical properties; clearly, relatively small dispersed-phase morphologies provide a commercial advantage because of the polymeric system's improved mechanical and chemical properties. In some cases, chemical stabilization of the dispersed minor phase is necessary (or the polymer-polymer blend compatibilized) so that its morphology remains small and stable—even under severe postmanufacturing operations.

Extruders are conventionally used in dispersion processes to produce dispersed-phase morphologies having an order of magnitude of approximately 1 micron. An explanation for current polymeric systems generally having consistent dispersed-phase morphologies of 1 micron is that a particular extruder's viscous and interfacial forces acting on the polymeric system's minor components are of the same magnitude as any other. For a typical continuous phase extrusion process (viscosity equal to 100 Pa-second and shear rate equal to 100 sec⁻¹), the shear (viscous) stresses responsible for breaking up the minor component into smaller domains are about 10,000 Pa. and have to balance the interfacial stresses acting on the surface of the dispersed particles (or polymer-polymer interfacial tension divided by the length scale of the dispersed phase). For a typical surface tension of about 0.01 N/m, the characteristic dimension of the dispersed particles to balance the characteristic viscous stresses is about 10⁻⁶ m (or 1 micron). Because of the inherent mechanical limitations—a typical extrusion process is incapable of producing polymeric systems having dispersed-phase morphologies less than 1 micron. It would therefore be of great scientific and commercial importance to design a commercially viable process comprising a mixing method yielding polymeric systems having dispersed-phase morphologies less than 1 micron-dispersed-phase morphologies smaller than those currently produced by conventional methods.

### SUMMARY OF THE INVENTION

In general, the present invention provides for a polymeric system wherein at least one minor polymeric component is dispersed into a major polymeric component such that the minor polymeric component(s) are dispersed with less than micro-scale, i.e, nano-scale, dispersed-phase morphologies.

The present invention also provides a method for dispersing at least one minor polymeric component, eventually having micro- and nano-scale dispersed-phase morphologies, into a major polymeric component comprising the steps of mixing the minor component into the major component using baker's transformation techniques, i.e., stretching and folding the composition, until two-dimensional sheets, i.e., domains, having thicknesses of preferably less than 1 micron are created, thereby promoting the onset of Rayleigh's instabilities that cause the sheets to break up into threads and eventually droplets of the same order of magnitude as the sheets. The invention may further include the step of forming an article of manufacture from the composition, typically by profile extrusion, compression or blow molding, or by thermoforming techniques. It will be appreciated that the step of forming may continue to add to the Rayleigh's instabilities, thereby continuing the break up of the sheets and threads into droplets preferably less than 1 micron in size.

Thus, the method of the present invention advantageously allows for the blending of at least two distinct polymeric components wherein one of the components, i.e., the minor component, will have micro- and nano-scale dispersed-phase morphologies. Where the above method is employed, multi-component polymeric systems having dispersed-phase morphologies of less than 1 micron can be manufactured.

It will also be appreciated that such polymeric systems, which are made by the method and processes of this invention, will have dispersed-phase morphologies of preferably less than 1 micron, i.e., less than those produced by conventional mixers, and therefore, will have relatively superior mechanical and chemical properties to those polymeric systems produced by conventional methods.

### BRIEF DESCRIPTION OF THE DRAWINGS

For a better understanding of the objects, techniques and structures of the invention, reference should be made to the following description and drawings. A preferred method incorporating the concepts of the present invention is shown by way of example in the accompanying drawings and description without attempting to show all variations, forms or modifications in which the invention might be embodied, it being understood that the invention is to be measured by the claims and not the details of the drawings and specification.

FIG. 1 presents a mechanism that explains the morphology progression in polymeric systems comprising at least two components, which are produced by the present invention.

FIG. 2 is an illustration of the principle of “stretching and folding”—the “baker's transformation.”

FIG. 3a is a scanning electron micrograph of the internal morphology of a polymeric system comprising polystyrene and polypropylene, 50/50 by volume, having layers with a starting thickness equal to 2 mm that was compression molded at 200° C. and annealed at the same temperature for 15 min., taken after four stretching, cutting, and stacking operations and showing partially broken layers and fibrillar domains.

FIG. 3b is a similar scanning electron micrograph of the internal morphology of a polymeric system comprising polystyrene and polypropylene, 50/50 by volume, having layers with a starting thickness equal to 2 mm that was compression molded at 200° C. and annealed at the same temperature for 15 min., taken after eight stretching, cutting, and stacking operations, with layers and fibris having broken up into a majority of particles about 50 microns in diameter and some being 1-10 microns.

FIG. 4 is an example of a preferred process utilizing the present invention's method to produce polymeric systems having micro- and nano-scale dispersed-phase morphologies.

FIG. 5 is a schematic representation of a general polymeric system comprising at least one minor component wherein the polymeric system has undergone four stretching, cutting, and stacking operations; the theoretical resulting stacked layers are shown.

FIGS. 6a, 6b, and 6c are scanning electron micrographs taken of the internal morphology of an actual polymeric system taken in section through line C-C as illustrated in FIG. 5 comprising polystyrene and polypropylene, 50/50 by volume, having layers with a starting thickness equal to 2 mm that was compression molded at 200° C. and annealed at the same temperature for 15 min., which were taken after four cutting and stacking operations and show partially broken layers and fibrillar domains.

FIG. 7 is a schematic representation of a general polymeric system comprising at least one minor component wherein the polymeric system has undergone four stretching, cutting, and stacking operations; the theoretical resulting stacked layers are shown.

FIGS. 8a, 8b, and 8c are scanning electron micrographs taken of the internal morphology of an actual polymeric system taken in section through the line D-D as illustrated in FIG. 7 comprising polystyrene and polypropylene, 50/50 by volume, having layers with a starting thickness equal to 2 mm that were compression molded at 200° C. and annealed at the same temperature for 15 min., which were taken after four cutting and stacking operations and show partially broken layers and fibrillar domains.

### DETAILED DESCRIPTION OF THE INVENTION

As noted hereinabove, the present invention relates to the dispersion of a minor component into a major component. The method involves the combination of two concepts or steps in mixing heretofore not used in the dispersion of minor phase components into major polymeric components. The first, a method of mixing known as “baker's transformation,” is based on principles of stretching and folding and transforms a multi-component polymeric system's minor component into sheets of material having small characteristic thickness. The second, known as Rayleigh instabilities, is caused by the generation of the sheets having small thicknesses. The onset and growth over time of Rayleigh's instabilities cause these thin, minor component sheets to break up into (preferably cylindrical) threads first and eventually into small droplets, which disperse into the major component.

“Baker's transformation” is an exponential way of mixing that comprises stretching and folding as depicted in FIG. 2. This manner of mixing was naturally titled the “baker's transformation” because it resembles the way dough is mixed by repeated rolling or stretching and folding. A variation on this mixing method involves stretching, cutting and stacking—with the last two steps being equivalent to the folding operation. Theoretically, the characteristic dimensions of a domain can be reduced by three orders of magnitude—from one mm to one micron, or from one micron to one nanometer—by repeating this “stretching, cutting, and stacking” process every ten (10) times. Static mixers such as AKZO's multiflux, Dow's Ross ISG, Sulzer's mixer, and Kenics, often utilize the “baker's transformation” method of mixing. When a minor component's original millimeter-size domains are stretched and folded into two-dimensional sheets, the characteristic length scale (sheet thickness) may be decreased to such a value (tens to hundreds of nanometers) that interfacial tension becomes important. Some dynamic mixers, such as extruders, are less efficient than their static counterparts in generating a high degree of “stretching and folding” of the material interfaces. That is, they fail to create minor component two-dimensional domains that promote the onset of Rayleigh instabilities. However, other dynamic mixers, such as chaotic mixers, are almost as suitable for use as static mixers, it being appreciated that chaotic mixers give rise to the same “stretching and folding” of the components as does static mixing. This explains the inherent limitation of some conventional mixers, i.e., extruders and the like, to produce dispersed phase morphologies of the nano-scale dimension, while others, i.e., chaotic mixers, can do so. It will be understood that where static mixers are discussed herein, any mixers (including chaotic mixers) capable of stretching and folding the components in a manner suitable to provide the “baker's transformation” method of mixing may be employed without departing from the spirit of the invention.

Upon reaching the necessary decreased sheet thickness, the interfacial forces tend to minimize the polymer to polymer interfacial area, minimizing the surface-to-volume ratio and preparing the second step of the present invention—Rayleigh instabilities setting in on the minor component's thin sheets. Rayleigh instabilities grow with time and cause the two-dimensional domains to break up into cylindrical threads first, and eventually into small droplets. The wavelength of these disturbances, and therefore the size of the final droplets, is of the same order of magnitude of the extended sheet's thickness—as small as hundreds or even tens of nanometers. Rayleigh instabilities will only set in if the minor component's domain reaches a minimum thickness.

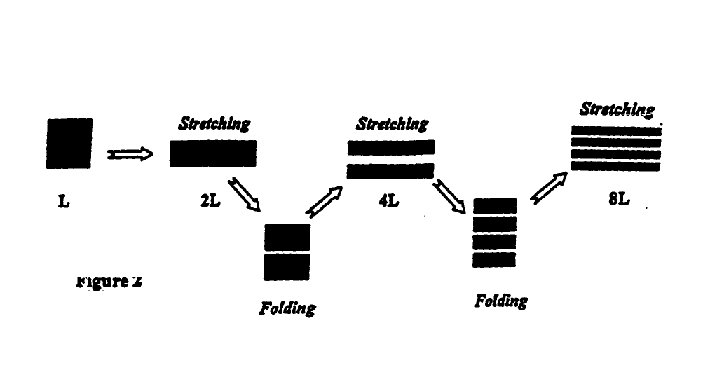

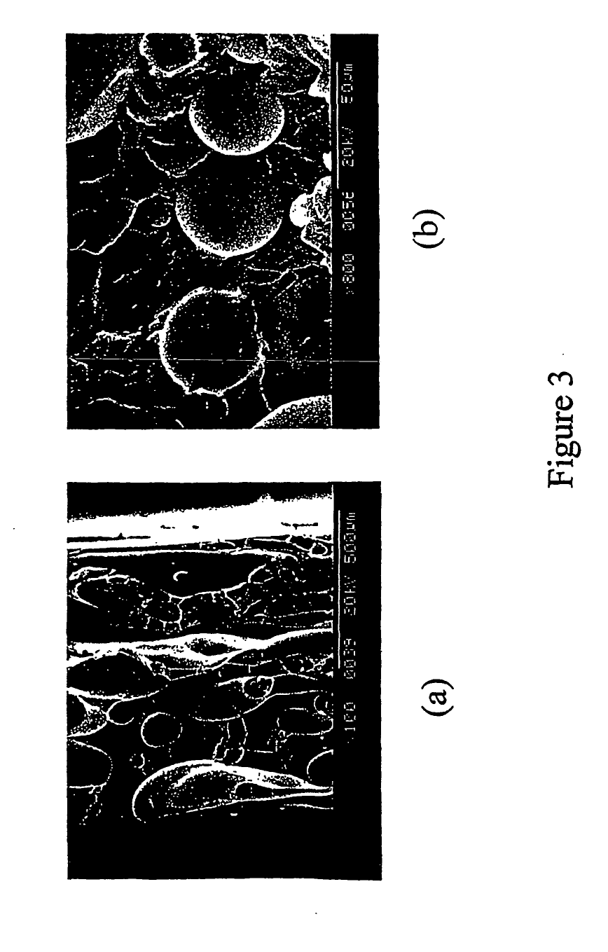

FIGS. 3a and 3b represent scanning electron micrographs illustrating the internal morphologies of a polymeric system comprising polystyrene and polypropylene, 50/50 by volume, having layers with a starting thickness equal to 2 mm that were compression molded at 200° C. and annealed at the same temperature for 15 min. The scanning electron micrographs of FIGS. 3a and 3b were taken after only four and eight stretching, cutting, and stacking operations, respectively, and they illustrate the partially broken layers and fibrillar domains. It will be appreciated that the viewing scale in FIG. 3a is that of 500 microns and the viewing scale in FIG. 3b is ten times smaller, which is that of 50 microns. Clearly, the dispersed-phase morphologies in FIG. 3a are far greater than those in FIG. 3b, and thus, the effectiveness of the present invention, i.e., the baker's transformation coupled with the onset of Raleigh instabilities, is readily apparent after only a difference of four stretching, cutting, and stacking operations. These results are encouraging since they show that an eight-fold stretching, cutting, and stacking process led to a reduction of the minor components initial characteristic thickness from 2 mm. to about 50 microns, or a reduction of about forty times. With additional stretching, cutting and stacking operations, the dispersed-phase morphologies will become even smaller. It is easy to visualize how additional stretching, cutting, and stacking operations would lead to dispersed phase morphologies progressing to a size of less than one micron and even nanometers.

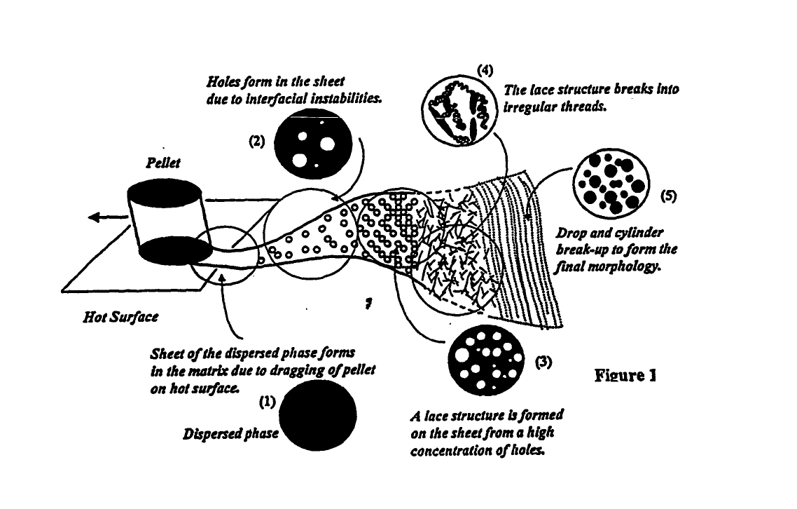

FIG. 1 illustrates the progression of Rayleigh instabilities upon a minor dispersed phase of small characteristic thickness. Step 1 of the illustrated process describes the creation of a minor phase of small characteristic thickness by dragging a pellet across a hot surface thereby creating a thin sheet on the hot surface. The very small characteristic thickness of the sheet produced in the first step encourages the onset of Rayleigh instabilities. The second step of the illustrated process goes on to demonstrate the initial interfacial instabilities, i.e., the onset of Rayleigh instabilities, which are illustrated by holes formed in the thin sheet produced in step 1. As the Rayleigh instabilities progress, a lattice structure is formed within the thin sheet. The lattice comprises a large concentration of holes in the sheet and makes it distinguishable from the earlier steps. When enough holes are concentrated within the sheet of small characteristic thickness, the process proceeds to step 4, wherein the sheet's lattice structure breaks into irregular threads. This leads to step 5, wherein the threads further break up to form the droplets of the final micro- or nano-scale dispersed-phase morphology.

It will be readily appreciated that these droplets are much smaller than the minor components currently found in conventional polymeric systems. Thus, the present invention has an advantageous characteristic in that it can produce dispersed-phase morphologies smaller than those micro-scale morphologies produced by conventional methods. The present invention has the capacity to provide morphologies more typically on the nano-scale. Thus, morphologies of less then 1 micron are preferred, with morphologies less than 800 and even less than 500 nanometers being even more preferred.

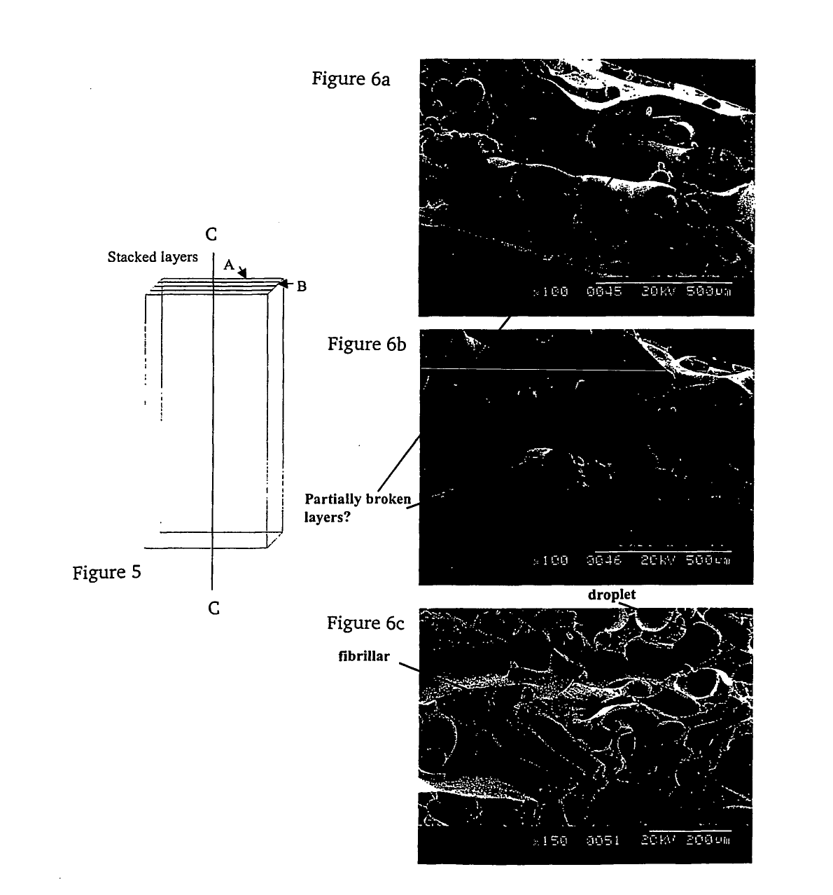

FIG. 5 is a schematic representation of a general polymeric system comprising at least a major and a minor component, which has undergone four stretching, cutting, and stacking operations. Layers, which are the result of the four stretching, cutting, and stacking operations, are illustrated and marked in the schematic representation as “a” and “b.” FIGS. 6a, 6b, and 6c are scanning electron micrographs of an actual polymeric system comprising polystyrene and propylene, 50/50 by volume, having layers with a starting thickness equal to 2 mm that were compression-molded at 200° C. and annealed at the same temperature for 15 minutes; the scanning electron micrographs were taken after four stretching, cutting, and stacking operations. These micrographs were taken of the layers exposed by the cut along the C-C plane as represented in FIG. 5. After only four cutting and stacking operations, it is apparent from the scanning electron micrographs that both the “baker's transformation” and the Rayleigh instabilities are efficiently dispersing the minor component into the major component. FIGS. 6a and 6b. illustrate the partially broken layers resulting from the baker's transformation; the approximate thickness of each of these layers is 100 microns. FIG. 6c clearly illustrates the Rayleigh instabilities resulting from the four cutting and stacking operations. Fibrillar domains, as well as the droplets coming therefrom, are illustrated therein. It will be appreciated that the scale used in FIGS. 6a and 6b are of the magnitude of 500 microns and the scale used in FIG. 6c is of the magnitude of 200 microns. What is shown in FIGS. 6a, 6b, and 6c is encouraging because it dearly illustrates the effectiveness of both the baker's transformation and the onset of Rayleigh instabilities in dispersing the minor component into the major component.

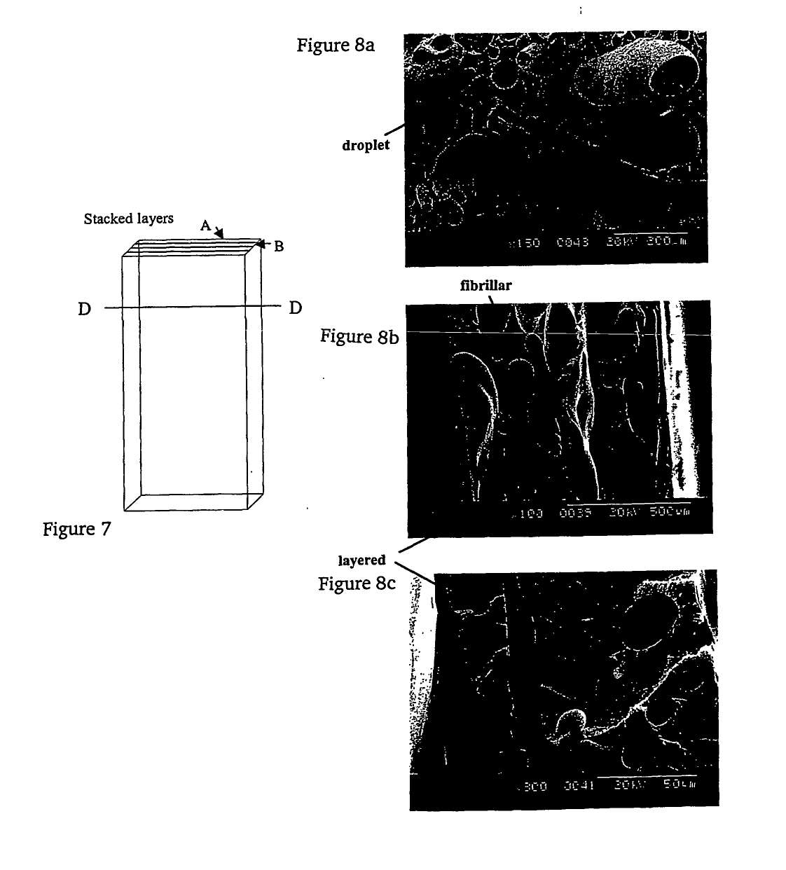

FIG. 7 is another schematic representation of a general polymeric system that has undergone four stretching, cutting, and stacking operations. Layers, which are the result of the four stretching, cutting, and stacking operations, are illustrated and marked in the schematic representation as “a” and “b.” FIG. 8a, 8b, and 8c are scanning electron micrographs of an actual polymeric system comprising polystyrene and polypropylene, 50/50 by volume, having layers with a starting thickness equal to 2 mm. that were compression-molded at 200° C. and annealed at the same temperature for 15 minutes; the scanning electron micrographs were taken after the polymeric system had undergone four stretching, cutting, and stacking operations and were taken of the layers exposed by the cut along the plane D-D as represented in FIG. 7. FIG. 8a illustrates both a fibrillar domain that progress to form droplets due to Rayleigh instabilities. FIG. 8b illustrates fibrillar domains as well as the layers resulting from the baker's transformation; the approximate thickness of each layer is 100 microns. FIG. 8c is an illustration of the layers resulting from the four stretching, cutting, and stacking operations. Again, all three of the scanning electron micrographs is encouraging because they illustrate the efficiency and effectiveness of the baker's transformation coupled with the onset of Raleigh instabilities in dispersing the minor component into the major component.

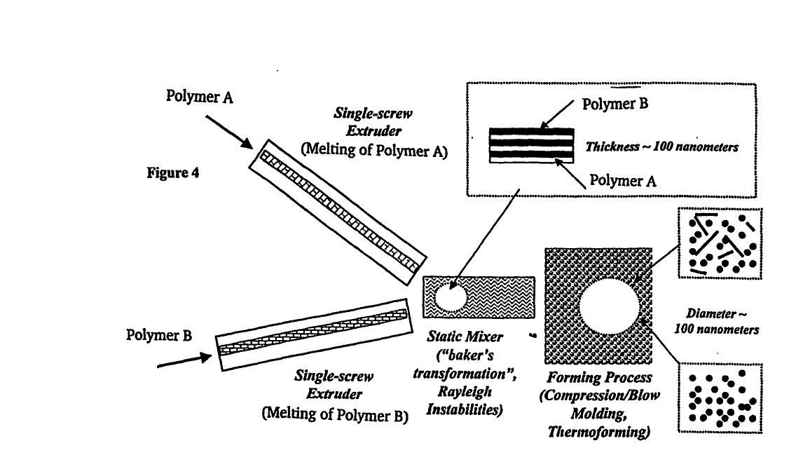

As illustrated in FIG. 4, an example of a commercially viable process comprising the present invention's method involves the following steps: First, two extruders, single or twin screw, must separately extrude each of the polymeric system's components into a separate mixer where the “baker's transformation” will take place. For example, one component might be a major component “Polymer A” and the other might be a minor component “Polymer B”. Second, once inside the static mixer where the “baker's transformation” occurs, after several stretching and folding steps, the minor polymeric component, via the “baker's transformation”, assumes such a small thickness as to promote the onset of Rayleigh instabilities. Third, the Rayleigh instabilities begin transforming the minor component's thin sheets into a dispersed-phase morphology of the micro- to nano-scale dimension. Only after completion of the “baker's transformation” within the mixer does the polymer system proceed to the forming step wherein profile extrusion, compression molding, blow molding, or thermoforming of an article may take place. It is at the forming step in the overall process that the Rayleigh instabilities go all the way to completion, i.e., causing the two-dimensional domain of the dispersed phase to break up into cylindrical threads and then finally small droplets. The wavelength of these disturbances, and therefore the size of the final droplets, is of the order of the thickness of the original extended sheet, or some tens of nanometers to a few microns. It is also seen as unique to this process that the present invention's method generates these small dispersed-phase morphologies in almost quiescent systems, i.e., under static conditions in the absence of almost any flow. It will be appreciated however, the some dynamic systems also may generate these nano-scale morphologies.

Compositions resulting from the present invention would have dispersed-phase morphologies that are smaller in size than those produced by conventional methods and, therefore, have relatively superior physical and chemical properties. Examples of these improved properties include, but are not limited to, impact strength, tensile strength, flexural rigidity, optical clarity, diffusion barriers, and reinforcement effects. Impact strength, tensile strength and flexural rigidity may be improved relative to conventional mixing methods because the nano-scale dispersed-phase morphologies bonded to the major polymeric component may increase these physical properties. However, in a worse case scenario, where the minor component is not effectively bonded to the major component, to nano-scale morphologies aid in not hindering the natural physical properties of the major component's polymer matrix. On the other hand, the larger dispersed-phase morphologies, which are a result of conventional mixing methods, oftentimes act as defects in the major component's polymer matrix and, therefore, tend to inhibit the major component's physical properties. The optical clarity of the polymeric system is improved because the present invention's nano-scale dispersed-phase morphologies allow for the transparency of the component, whereas the conventional methods' micro-scale dispersed-phase morphologies result only in translucency of the component. The polymer system of the present invention also acts as a barrier to diffusion of small molecules due to the nano-scale dispersed-phase morphologies. These smaller morphologies result in a more compact polymer matrix. Finally, the polymer system provides reinforcement effects with solid inorganic fillers such as glass and carbon fibers. Reinforcement is improved because the nano-scale dispersed-phase morphologies have greater surface area. Therefore, the nano-scale dispersed-phase morphologies have more surface area to cover the surface interface of the glass and carbon fibers.

In light of the foregoing, it should thus be evident that the method of the present invention, which provides micro- or nano-scale dispersed-phase morphologies in polymeric systems comprising at least two components, substantially improves the art While, in accordance with the patent statutes, only the preferred embodiments of the present invention have been described in detail hereinabove, the present invention is not to be limited thereto or thereby. Rather, the scope of the invention shall include all modifications and variations that fall within the scope of the claims.

1. A polymeric system wherein at least one minor polymeric component is dispersed into a major polymeric component such that the at least one minor polymeric component is dispersed with less than micro-scale dispersed-phase morphologies.

2. The polymeric system as set forth in claim 1 wherein the at least one minor polymeric component is dispersed with less than 800 nanometer dispersed-phase morphologies.

3. A method for dispersing at least one minor polymeric component into a major polymeric component comprising the steps of:
mixing the at least one minor component into the major component using baker's transformation techniques until two-dimensional sheets having thicknesses of less than 1 micron are created; and
promoting the onset of Rayleigh's instabilities that cause the sheets to break up into threads and eventually droplets of the same order of magnitude of thickness as the sheets.

4. The method for dispersing as set forth in claim 3, wherein sheets having a thickness of less than 800 nanometers are created.

5. A method for forming an article of manufacture molded from a major polymeric component and at least one minor polymeric component, comprising the steps of:
mixing the at least one minor component into the major component to form a polymer system by using baker's transformation techniques until two-dimensional sheets having thicknesses of less than 1 micron are created;
promoting the onset of Rayleigh's instabilities that cause the sheets to break up into threads and eventually droplets of the same order of magnitude of thickness as the sheets; and
molding the polymer system into the article of manufacture and further promoting the onset of Rayleigh's instabilities during formation of the article of manufacture

6. The method as set forth in claim 5, wherein the step of molding is conducted by profile extrusion.

7. The method as set forth in claim 5, wherein the step of molding is conducted by compression or blow molding.

8. The method as set forth in claim 5, wherein the step of molding is conducted using thermoforming techniques.

9. A polymer system mixing process comprising:
mixing a major polymeric component and a minor polymeric component together via “baker's transformation” in order to create sheets of a polymer system having a thickness of up to one micron;,
causing the onset of Rayleigh's instabilities, thereby reducing the size of the polymer system's minor component to less than one micron.

10. The polymer system mixing process as set forth in claim 9, further comprising:
molding the polymer system to thereby allow the Rayleigh instabilities to completely disperse the minor component.

11. The polymer system mixing process of claim 9, wherein the “baker's transformation” consists of stretching and folding the polymer system.

12. The polymer system mixing process of claim 9, wherein the “baker's transformation” consists of stretching, cutting, and stacking the polymer system.

13. The polymer system mixing process of claim 9, wherein the major and minor components of the polymer systems are selected from the group consisting of:
polystyrene, polypropylene, polycarbonate, acrylonitrile-butadiene-styrene, compatibilized polyphenylene ether, nylon, polybutylene terephthalate, styrene-acrylonitrile, and polybutadiene.

14. The polymer-system mixing process of claim 9, wherein the step of mixing including utilizing a mixer selected from the group consisting of static mixers and chaotic mixers.
